(19) United States
(12) Patent Application Publication
(10) Pub. No.: US 2013/0162574 A1
(43) Pub. Date: Jun. 27, 2013

(54) DEVICE, METHOD, AND STORAGE MEDIUM STORING PROGRAM

(71) Applicant: KYOCERA CORPORATION, Kyoto-shi (JP)

(72) Inventor: Mitsutoshi KOBAYASHI, Yokohama-shi (JP)

(73) Assignee: KYOCERA CORPORATION, Kyoto-shi (JP)

(21) Appl. No.: 13/726,275

(22) Filed: Dec. 24, 2012

(30) Foreign Application Priority Data
Dec. 27, 2011 (JP) 2011-286077

(51) Int. Cl. G06F 3/0488

(52) U.S. Cl. CPC G06F 3/0488
USPC 345/173

(57) ABSTRACT

According to an aspect, a device includes a touch screen display and a controller. The touch screen display displays a lock screen and a first object that moves on the lock screen. When a gesture is performed on the first object, the controller releases a locked state in which the lock screen is displayed.

### CROSS-REFERENCE TO RELATED APPLICATIONS

This application claims priority from Japanese Application No. 2011-286077, filed on Dec. 27, 2011, the content of which is incorporated by reference herein in its entirety.

### BACKGROUND

1. Technical Field

The present application relates to a device, a method, and a storage medium storing therein a program. More particularly, the present application relates to a device including a touch screen, a method of controlling the device, and a storage medium storing therein a program for controlling the device.

2. Description of the Related Art

A touch screen device having a touch screen has been known. Examples of the touch screen devices include, but are not limited to, a smartphone and a tablet. The touch screen device detects a gesture of a finger, a pen, or a stylus pen through the touch screen. Then, the touch screen device operates according to the detected gesture. An example of the operation according to the detected gesture is described in, for example, International Publication Pamphlet No. 2008/086302.

The basic operation of the touch screen device is implemented by an operating system (OS) built into the device. Examples of the OS built into the touch screen device include, but are not limited to, Android, BlackBerry OS, iOS, Symbian OS, and Windows Phone.

Many of touch screen devices move to a locked state from the viewpoint of prevention of user's malfunction and security if the time when a user's operation is not accepted continues to some extent. In the locked state, the touch screen device does not accept any operation from the user except for a specific operation. The specific operation is, for example, a lock-release operation for releasing the locked state.

In this manner, the touch screen device frequently moves to the locked state, and therefore the user performs the lock-release operation frequently. For these reasons, there is a need for a device, a method, and a program capable of improving operability of the lock-release operation.

### SUMMARY

According to an aspect, a device includes a touch screen display and a controller. The touch screen display displays a lock screen and a first object that moves on the lock screen. When a gesture is performed on the first object, the controller releases a locked state in which the lock screen is displayed.

According to another aspect, a method is for controlling a device with a touch screen display. The method includes: displaying a lock screen and a first object that moves on the lock screen on the touch screen display; and releasing, when a gesture is performed on the first object, a locked state in which the lock screen is displayed.

According to another aspect, a non-transitory storage medium stores a program. When executed by a device with a touch screen display, the program causes the device to execute: displaying a lock screen and a first object that moves on the lock screen on the touch screen display; and releasing, when a gesture is performed on the first object, a locked state in which the lock screen is displayed.

### BRIEF DESCRIPTION OF THE DRAWINGS

FIG. 1 is a perspective view of a smartphone according to an embodiment;

FIG. 2 is a front view of the smartphone;

FIG. 3 is a back view of the smartphone;

FIG. 4 is a diagram illustrating an example of a home screen;

FIG. 5 is a diagram illustrating an example of a lock screen;

FIG. 6 is a diagram illustrating an example of the lock screen;

FIG. 7 is a block diagram of the smartphone;

FIG. 8 is a diagram illustrating an example of control performed when a touch gesture performed on an object that moves on the lock screen is detected;

FIG. 9 is a diagram illustrating another example of the control performed when a touch gesture performed on an object that moves on the lock screen is detected;

FIG. 10 is a diagram illustrating an example of the control to change a moving speed of the object displayed on a lock screen 60 and a size of an icon included in the object according to a use frequency of an application;

FIG. 11 is a diagram illustrating an example of changing a display mode according to an event that occurs in relation to the application; and

FIG. 12 is a diagram illustrating a procedure for executing a process associated with an object according to a touch gesture performed on the object detected by a touch screen.

### DETAILED DESCRIPTION

Exemplary embodiments of the present invention will be explained in detail below with reference to the accompanying drawings. A smartphone will be explained below as an example of a device including a touch screen.

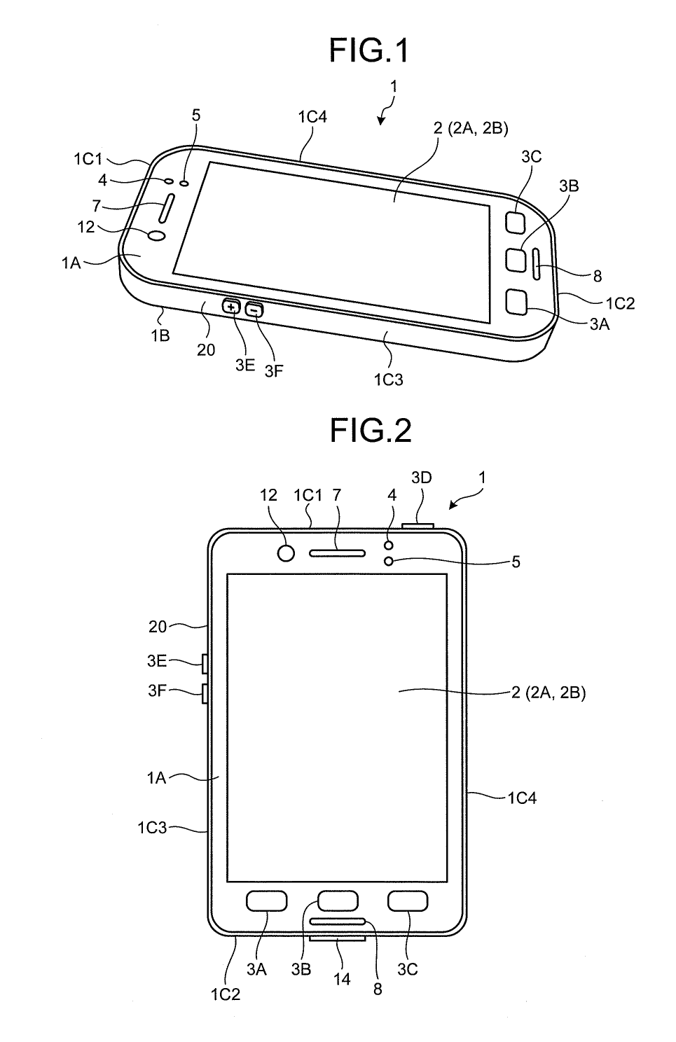

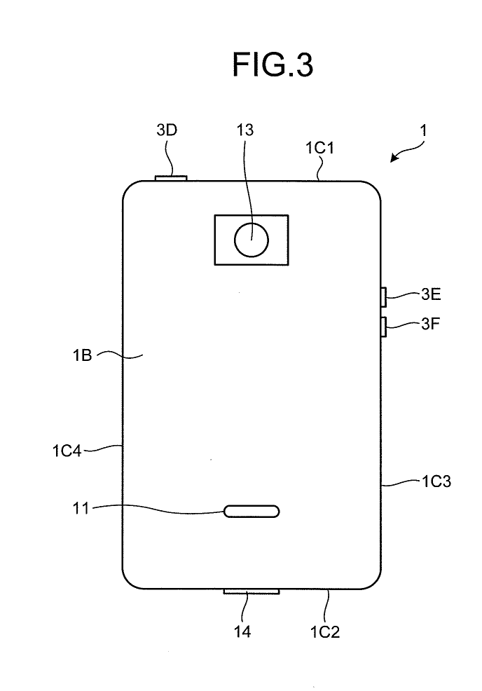

An overall configuration of a smartphone 1 according to an embodiment will be explained below with reference to FIG. 1 to FIG. 3. As illustrated in FIG. 1 to FIG. 3, the smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 includes a touch screen display 2, buttons 3A to 3C, an illumination (ambient light) sensor 4, a proximity sensor 5, a receiver 7, a microphone 8, and a camera 12, which are provided in the front face 1A. The smartphone 1 includes a speaker 11 and a camera 13, which are provided in the back face 1B. The smartphone 1 includes buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. In the example of FIG. 1, each of the display 2A and the touch screen 2B is approximately rectangular-shaped; however, the shapes of the display 2A and the touch screen 2B are not limited thereto. Each of the display 2A and the touch screen 2B may have any shape such as a square, a circle or the like. In the example of FIG. 1, the display 2A and the touch screen 2B are arranged in a superimposed manner; however, the manner in which the display 2A and the touch screen 2B are arranged is not limited thereto. The display 2A and the touch screen 2B may be arranged, for example, side by side or apart from each other. In the example of FIG. 1, longer sides of the display 2A are along with longer sides of the touch screen 2B respectively while shorter sides of the display 2A are along with shorter sides of the touch screen 2B respectively; however, the manner in which the display 2A and the touch screen 2B are superimposed is not limited thereto. In case the display 2A and the touch screen 2B are arranged in the superimposed manner, they can be arranged such that, for example, one or more sides of the display 2A are not along with any sides of the touch screen 2B.

The display 2A is provided with a display device such as a liquid crystal display (LCD), an organic electro-luminescence display (OELD), or an inorganic electro-luminescence display (IELD). The display 2A displays text, images, symbols, graphics, and the like.

The touch screen 2B detects a contact of a finger, a pen, a stylus pen, or the like on the touch screen 2B. The touch screen 2B can detect positions where a plurality of fingers, pens, stylus pens, or the like make contact with the touch screen 2B.

The detection method of the touch screen 2B may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. In the description herein below, for the sake of simplicity, it is assumed that the user uses his/her finger(s) to make contact with the touch screen 2B in order to operate the smartphone 1.

The smartphone 1 determines a type of a gesture based on at least one of a contact detected by the touch screen 2B, a position where the contact is detected, a change of a position where the contact is detected, an interval between detected contacts, and the number of detection times of the contact. The gesture is an operation performed on the touch screen 2B. Examples of the gestures determined by the smartphone 1 include, but are not limited to, touch, long touch, release, swipe, tap, double tap, long tap, drag, flick, pinch in, and pinch out.

“Touch” is a gesture in which a finger makes contact with the touch screen 2B. The smartphone 1 determines a gesture in which the finger makes contact with the touch screen 2B as touch. “Long touch” is a gesture in which a finger makes contact with the touch screen 2B for longer than a given time. The smartphone 1 determines a gesture in which the finger makes contact with the touch screen 2B for longer than a given time as long touch.

“Release” is a gesture in which a finger separates from the touch screen 2B. The smartphone 1 determines a gesture in which the finger separates from the touch screen 2B as release. “Swipe” is a gesture in which a finger moves on the touch screen 2B with continuous contact thereon. The smartphone 1 determines a gesture in which the finger moves on the touch screen 2B with continuous contact thereon as swipe.

“Tap” is a gesture in which a touch is followed by a release. The smartphone 1 determines a gesture in which a touch is followed by a release as tap. “Double tap” is a gesture such that a gesture in which a touch is followed by a release is successively performed twice. The smartphone 1 determines a gesture such that a gesture in which a touch is followed by a release is successively performed twice as double tap.

“Long tap” is a gesture in which a long touch is followed by a release. The smartphone 1 determines a gesture in which a long touch is followed by a release as long tap. “Drag” is a gesture in which a swipe is performed from an area where a movable-object is displayed. The smartphone 1 determines a gesture in which a swipe is performed from an area where the movable-object displayed as drag.

“Flick” is a gesture in which a finger separates from the touch screen 2B while moving after making contact with the touch screen 2B. That is, “Flick” is a gesture in which a touch is followed by a release accompanied with a movement of the finger. The smartphone 1 determines a gesture in which the finger separates from the touch screen 2B while moving after making contact with the touch screen 2B as flick. The flick is performed, in many cases, with a finger moving along one direction. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like. Movement of the finger during the flick is, in many cases, quicker than that of the finger during the swipe.

“Pinch in” is a gesture in which a swipe with a plurality of fingers is performed in a direction to move the fingers toward each other. The smartphone 1 determines a gesture in which the distance between a position of one finger and a position of another finger detected by the touch screen 2B becomes shorter as pinch in. “Pinch out” is a gesture in which a swipe with a plurality of fingers is performed in a direction to move the fingers away from each other. The smartphone 1 determines a gesture in which the distance between a position of one finger and a position of another finger detected by the touch screen 2B becomes longer as pinch out.

In the description herein below, a gesture performed by using a finger may be referred to as a “single touch gesture”, and a gesture performed by using a plurality of fingers may be referred to as a “multi touch gesture”. Examples of the multi touch gesture include a pinch in and a pinch out. A tap, a flick, a swipe, and the like are a single touch gesture when performed by using a finger, and are a multi touch gesture when performed by using a plurality of fingers.

The smartphone 1 performs operations according to these gestures which are determined through the touch screen 2B. Therefore, user-friendly and intuitive operability is achieved. The operations performed by the smartphone 1 according to the determined gestures may be different depending on the screen displayed on the display 2A. In the following explanation, for the sake of simplicity of explanation, the fact that the touch screen detects the contact(s) and then the smartphone determines the type of the gesture as X based on the contact(s) may be simply described as “the smartphone detects X” or “the controller detects X”.

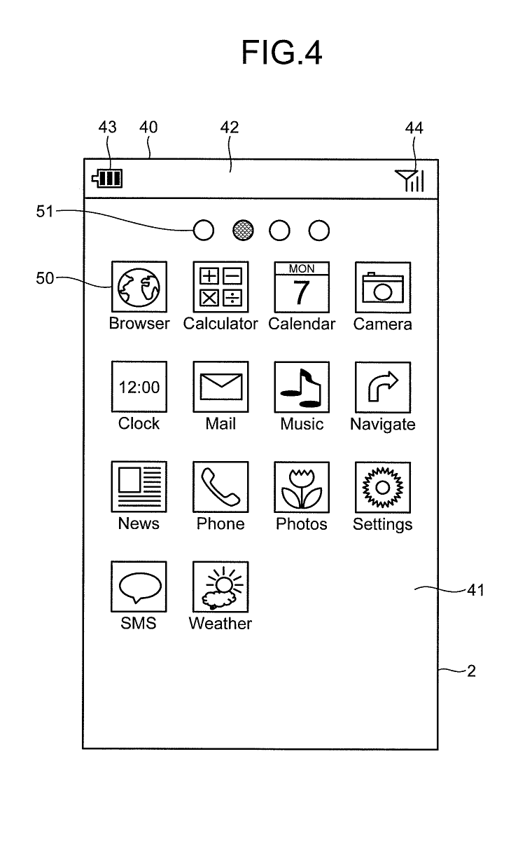

An example of the screen displayed on the display 2A will be explained below with reference to FIG. 4. FIG. 4 represents an example of a home screen. The home screen may also be called “desktop”, “standby screen”, “idle screen”, or “standard screen”. The home screen is displayed on the display 2A. The home screen is a screen allowing the user to select which one of applications (programs) installed in the smartphone 1 is executed. The smartphone 1 executes the application selected on the home screen in the foreground. The screen of the application executed in the foreground is displayed on the display 2A.

Icons can be arranged on the home screen of the smartphone 1. A plurality of icons 50 are arranged on a home screen 40 illustrated in FIG. 4. Each of the icons 50 is previously associated with an application installed in the smartphone 1. When detecting a gesture for an icon 50, the smartphone 1 executes the application associated with the icon 50 for which the gesture is detected. For example, when detecting a tap on an icon 50 associated with a mail application, the smartphone 1 executes the mail application.

The icons 50 include an image and a character string. The icons 50 may contain a symbol or a graphic instead of an image. The icons 50 do not have to include either one of the image and the character string. The icons 50 are arranged based on a layout pattern. A wall paper 41 is displayed behind the icons 50. The wall paper may sometimes be called “photo screen”, “back screen”, “idle image”, or “background image”. The smartphone 1 can use an arbitrary image as the wall paper 41. The smartphone 1 may be configured so that the user can select an image to be displayed as the wall paper 41.

The smartphone 1 can include a plurality of home screens. The smartphone 1 determines, for example, the number of home screens according to setting by the user. The smartphone 1 displays a selected one on the display 2A even when there is a plurality of home screens.

The smartphone 1 displays an indicator (a locator) 51 on the home screen. The indicator 51 includes one or more symbols. The number of the symbols is the same as that of the home screens. In the indicator 51, a symbol corresponding to a home screen that is currently displayed is displayed in a different manner from that of symbols corresponding to the other home screens.

The indicator 51 in an example illustrated in FIG. 4 includes four symbols. This means the number of home screens is four. According to the indicator 51 in the example illustrated in FIG. 4, the second symbol from the left is displayed in a different manner from that of the other symbols. This means that the second home screen from the left is currently displayed.

The smartphone 1 can change a home screen to be displayed on the display 2A. When a gesture is detected while displaying one of home screens, the smartphone 1 changes the home screen to be displayed on the display 2A to another one. For example, when detecting a rightward flick, the smartphone 1 changes the home screen to be displayed on the display 2A to a home screen on the left side. For example, when detecting a leftward flick, the smartphone 1 changes the home screen to be displayed on the display 2A to a home screen on the right side. The smartphone 1 changes the home screen to be displayed on the display 2A from a first home screen to a second home screen, when a gesture is detected while displaying the first home screen, such that the area of the first home screen displayed on the display 2A gradually becomes smaller and the area of the second home screen displayed gradually becomes larger. The smartphone 1 may switch the home screens such that the first home screen is instantly replaced by the second home screen.

An area 42 is provided along the top edge of the display 2A. Displayed on the area 42 are a remaining mark 43 indicating a remaining amount of a power supply and a radio-wave level mark 44 indicating an electric field strength of radio wave for communication. The smartphone 1 may display time, weather, an application during execution thereof, a type of communication system, a status of a phone call, a mode of the device, an event occurring in the device, and the like in the area 42. In this manner, the area 42 is used to inform the user of various notifications. The area 42 may be provided on any screen other than the home screen 40. A position where the area 42 is provided is not limited to the top edge of the display 2A.

The home screen 40 illustrated in FIG. 4 is only an example, and therefore the configuration of each of elements, the arrangement of the elements, the number of home screens 40, the way to perform each of operations on the home screen 40, and the like do not have to be like the above mentioned explanation.

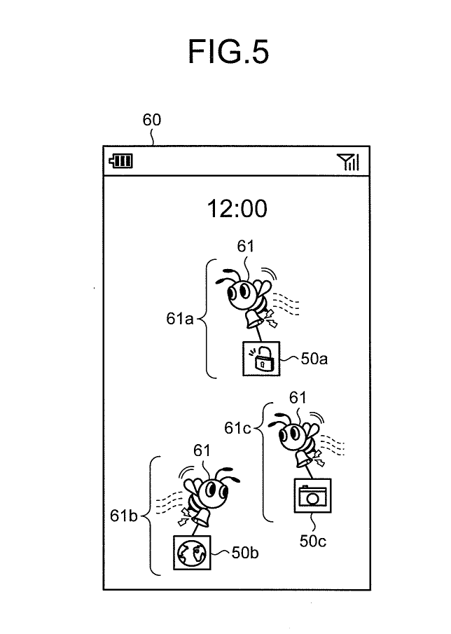

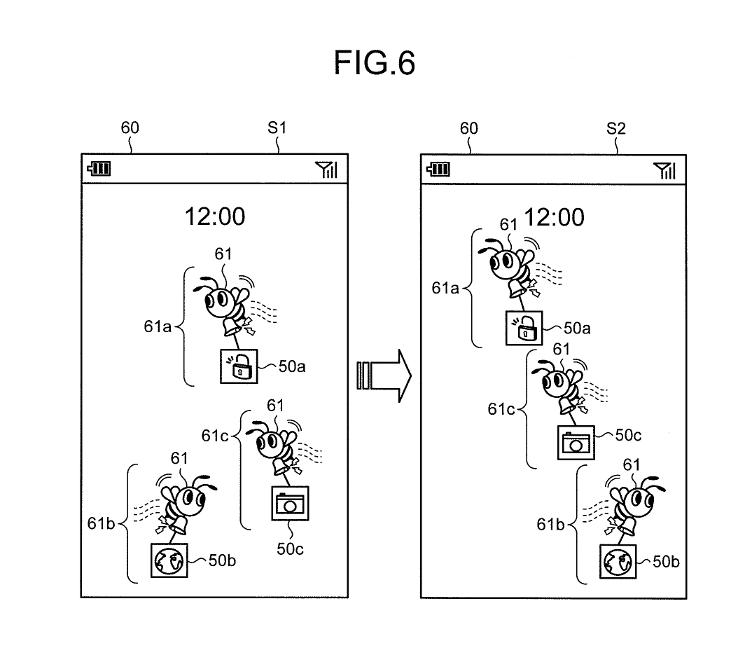

An example of the lock screen displayed on the display 2A will be explained below with reference to FIG. 5 and FIG. 6. FIG. 5 and FIG. 6 are diagrams illustrating an example of the lock screen. As well as the home screen 40 in FIG. 4, the smartphone 1 displays the lock screen 60 in FIG. 5 and FIG. 6 on the display 2A. The lock screen 60 generally accepts only a specific operation including a release operation of the locked state from the viewpoint of prevention of user's malfunction and security. In the present embodiment, on the other hand, as a purpose of widening its usage in the state of displaying the lock screen 60, the lock screen 60 accepts various operations other than the specific operation such as an operation for displaying the lock screen 60 on the display 2A and a lock-release operation for releasing the locked state. Hereinafter, for the sake of convenience of explanation, a state in which the lock screen 60 is displayed on the display 2A may be referred to as “locked state”.

The lock screen 60 in FIG. 5 displays an object 61a including an image 61 of a bee, an object 61b including an image 61 of a bee, and an object 61c including an image 61 of a bee. The object 61a includes the image 61 and an icon 50a corresponding to a function for releasing the locked state. The object 61b includes the image 61 and an icon 50b corresponding to a browser application that provides a WEB browsing function. The object 61c includes the image 61 and an icon 50c corresponding to a camera application that provides an imaging function. The object 61a including the image 61 is an example of the first object. The object 61b including the image 61 and the object 61c including the image 61 are examples of a second object.

As illustrated at Step S1 and Step S2 in FIG. 6, the object 61a, the object 61b, and the object 61c displayed on the lock screen 60 randomly move around on the lock screen 60 during display of the lock screen 60 on the display 2A. For example, when reaching an edge of the lock screen 60, the objects 61a to 61c turn and move in the opposite direction. Alternatively, when reaching an edge of the lock screen 60, the objects 61a to 61c disappear as if they are sucked into the edge of the lock screen 60, and again appear from another edge of the lock screen 60 and move. FIG. 5 depicts an example of displaying the three objects 61a to 61c on the lock screen 60; however, the number of objects displayed on the lock screen 60 is not limited to the examples of FIG. 5 and FIG. 6.

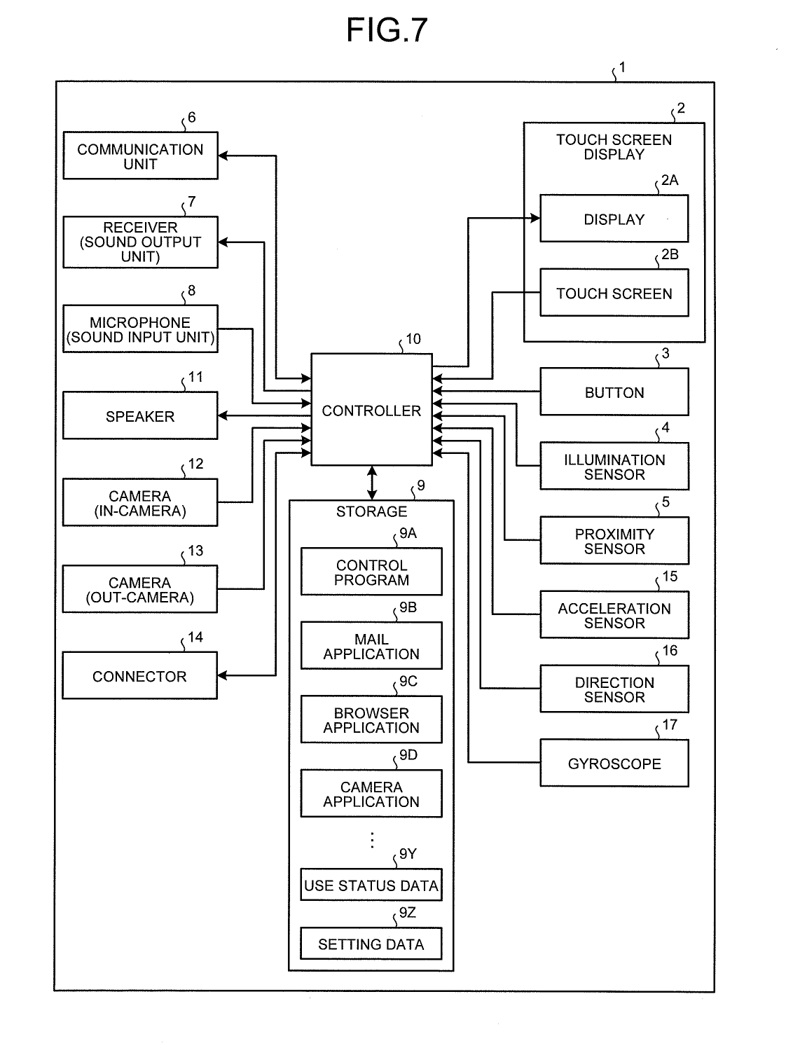

FIG. 7 is a block diagram of the smartphone 1. The smartphone 1 includes the touch screen display 2, the button 3, the illumination sensor 4, the proximity sensor 5, a communication unit 6, the receiver 7, the microphone 8, a storage 9, a controller 10, the speaker 11, the cameras 12 and 13, the connector 14, an acceleration sensor 15, a direction (orientation) sensor 16, and a gyroscope 17.

The touch screen display 2 includes, as explained above, the display 2A and the touch screen 2B. The display 2A displays text, images, symbols, graphics, or the like. The touch screen 2B detects contact(s). The controller 10 detects a gesture performed for the smartphone 1. Specifically, the controller 10 detects an operation (a gesture) for the touch screen 2B in cooperation with the touch screen 2B.

The button 3 is operated by the user. The button 3 includes buttons 3A to 3F. The controller 10 detects an operation for the button 3 in cooperation with the button 3. Examples of the operations for the button 3 include, but are not limited to, a click, a double click, a triple click, a push, and a multi-push.

The buttons 3A to 3C are, for example, a home button, a back button, or a menu button. The button 3D is, for example, a power on/off button of the smartphone 1. The button 3D may function also as a sleep/sleep release button. The buttons 3E and 3F are, for example, volume buttons.

The illumination sensor 4 detects illumination of the ambient light of the smartphone 1. The illumination indicates intensity of light, lightness, or brightness. The illumination sensor 4 is used, for example, to adjust the brightness of the display 2A. The proximity sensor 5 detects the presence of a nearby object without any physical contact. The proximity sensor 5 detects the presence of the object based on a change of the magnetic field, a change of the return time of the reflected ultrasonic wave, etc. The proximity sensor 5 detects that, for example, the touch screen display 2 is brought close to someone's face. The illumination sensor 4 and the proximity sensor 5 may be configured as one sensor. The illumination sensor 4 can be used as a proximity sensor.

The communication unit 6 performs communication via radio waves. A communication system supported by the communication unit 6 is wireless communication standard. The wireless communication standard includes, for example, a communication standard of cellar phones such as 2G, 3G, and 4G. The communication standard of cellar phones includes, for example, Long Term Evolution (LTE), Wideband Code Division Multiple Access (W-CDMA), CDMA 2000, a Personal Digital Cellular (PDC), a Global System for Mobile Communications (GSM), and a Personal Handy-phone System (PHS). The wireless communication standard further includes, for example, Worldwide Interoperability for Microwave Access (WiMAX), IEEE 802.11, Bluetooth, Infrared Data Association (IrDA), and Near Field Communication (NFC). The communication unit 6 may support one or more communication standards.

The receiver 7 and the speaker 11 are sound output units. The receiver 7 and the speaker 11 output a sound signal transmitted from the controller 10 as sound. The receiver 7 is used, for example, to output voice of the other party on the phone. The speaker 11 is used, for example, to output a ring tone and music. Either one of the receiver 7 and the speaker 11 may double as the other function. The microphone 8 is a sound input unit. The microphone 8 converts speech of the user or the like to a sound signal and transmit the converted signal to the controller 10.

The storage 9 stores therein programs and data. The storage 9 is used also as a work area that temporarily stores a processing result of the controller 10. The storage 9 may include any non-transitory storage medium such as a semiconductor storage medium and a magnetic storage medium. The storage 9 may include a plurality type of storage mediums. The storage 9 may include a combination of a portable storage medium such as a memory card, an optical disc, or a magneto-optical disc with a reader of the storage medium. The storage 9 may include a storage device used as a temporary storage area such as Random Access Memory (RAM).

Programs stored in the storage 9 include applications executed in the foreground or the background and a control program for assisting operations of the applications. The application causes the controller 10, for example, to display a screen on the display 2A and perform a process according to a gesture detected through the touch screen 2B. The control program is, for example, an OS. The applications and the control program may be installed in the storage 9 through communication by the communication unit 6 or through a non-transitory storage medium.

The storage 9 stores therein, for example, a control program 9A, a mail application 9B, a browser application 9C, a camera application 9D, use status data 9Y, and setting data 9Z. The mail application 9B provides an e-mail function. The e-mail function allows composition, transmission, reception, and display of e-mail, and the like. The browser application 9C provides a WEB browsing function. The WEB browsing function allows display of WEB pages, and edit of a book mark, and the like. The use status data 9Y contains information related to use statuses of applications installed into the smartphone 1. For example, the use status data 9Y includes items such as Screen, Row, Column, Image, Name, Installation Date/Time, Number of Use Times, and Last Use Date/Time, and holds data for each application installed into the smartphone 1. The setting data 9Z contains information related to various settings on the operations of the smartphone 1. The storage 9 stores therein, for example, an average of the number of use times per day for each application.

The control program 9A provides a function related to various controls for operating the smartphone 1. The control program 9A controls, for example, the communication unit 6, the receiver 7, and the microphone 8 to make a phone call. The function provided by the control program 9A includes a function for displaying the lock screen 60 on the display 2A. The function provided by the control program 9A further includes a function for releasing the locked state when a touch gesture preformed on the first object that moves on the lock screen 60 is detected. Moreover, the function provided by the control program 9A includes a function for executing an application associated with a second object when a touch gesture preformed on the second object that moves on the lock screen 60 is detected. The functions provided by the control program 9A can be used in combination with a function provided by the other program such as the mail application 9B.

The controller 10 is a processing unit. Examples of the processing units include, but are not limited to, a Central Processing Unit (CPU), System-on-a-chip (SoC), a Micro Control Unit (MCU), and a Field-Programmable Gate Array (FPGA). The controller 10 integrally controls the operations of the smartphone 1 to implement various functions.

Specifically, the controller 10 executes instructions contained in the program stored in the storage 9 while referring to the data stored in the storage 9 as necessary. The controller 10 controls a function unit according to the data and the instructions to thereby implement the various functions. Examples of the function units include, but are not limited to, the display 2A, the communication unit 6, the receiver 7, and the speaker 11. The controller 10 can change the control of the function unit according to the detection result of a detector. Examples of the detectors include, but are not limited to, the touch screen 2B, the button 3, the illumination sensor 4, the proximity sensor 5, the microphone 8, the camera 12, the camera 13, the acceleration sensor 15, the direction sensor 16, and the gyroscope 17.

The controller 10 executes, for example, the control program 9A to thereby release the locked state when a touch gesture preformed on the first object that moves on the lock screen 60 is detected. Also, the controller 10 executes the control program 9A to thereby execute an application associated with a second object when a touch gesture preformed on the second object that moves on the lock screen 60 is detected.

The camera 12 is an in-camera for photographing an object facing the front face 1A. The camera 13 is an out-camera for photographing an object facing the back face 1B.

The connector 14 is a terminal to which other device is connected. The connector 14 may be a general-purpose terminal such as a Universal Serial Bus (USB), a High-Definition Multimedia Interface (HDMI), Light Peak (Thunderbolt), and an earphone/microphone connector. The connector 14 may be a dedicated terminal such as a dock connector. Examples of the devices connected to the connector 14 include, but are not limited to, an external storage device, a speaker, and a communication device.

The acceleration sensor 15 detects a direction and a magnitude of acceleration applied to the smartphone 1. The direction sensor 16 detects a direction of geomagnetism. The gyroscope 17 detects an angle and an angular velocity of the smartphone 1. The detection results of the acceleration sensor 15, the direction sensor 16, and the gyroscope 17 are used in combination with each other in order to detect a position of the smartphone 1 and a change of its attitude.

Part or all of the programs and the data stored in the storage 9 in FIG. 7 may be downloaded from any other device through communication by the communication unit 6. Part or all of the programs and the data stored in the storage 9 in FIG. 7 may be stored in the non-transitory storage medium that can be read by the reader included in the storage 9. Part or all of the programs and the data stored in the storage 9 in FIG. 7 may be stored in the non-transitory storage medium that can be read by a reader connected to the connector 14. Examples of the non-transitory storage mediums include, but are not limited to, an optical disc such as CD, DVD, and Blu-ray, a magneto-optical disc, magnetic storage medium, a memory card, and solid-state storage medium.

The configuration of the smartphone 1 illustrated in FIG. 7 is only an example, and therefore it can be modified as required within a scope that does not depart from the gist of the present invention. For example, the number and the type of the button 3 are not limited to the example of FIG. 7. The smartphone 1 may be provided with buttons of a numeric keypad layout or a QWERTY layout and so on as buttons for operation of the screen instead of the buttons 3A to 3C. The smartphone 1 may be provided with only one button to operate the screen, or with no button. In the example of FIG. 7, the smartphone 1 is provided with two cameras; however, the smartphone 1 may be provided with only one camera or with no camera. In the example of FIG. 7, the smartphone 1 is provided with three types of sensors in order to detect its position and attitude; however, the smartphone 1 does not have to be provided with some of the sensors. Alternatively, the smartphone 1 may be provided with any other type of sensor for detecting at least one of the position and the attitude.

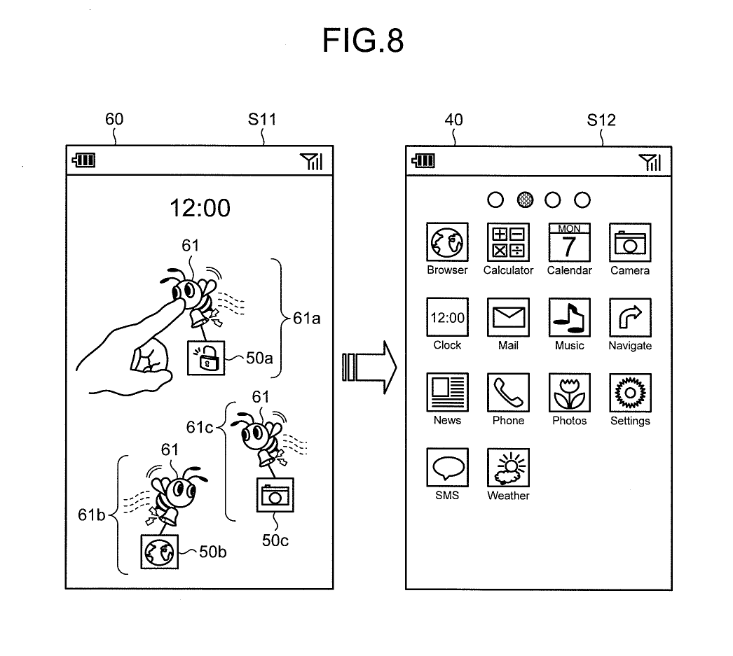

Examples of the controls based on the functions provided by the control program 9A will be explained below with reference to FIG. 8 to FIG. 10. The functions provided by the control program 9A include a function for releasing a locked state upon detecting a touch gesture performed on the first object that moves on the lock screen 60, and a function for executing an application associated with the second object upon detecting a touch gesture performed on the second object that moves on the lock screen 60.

FIG. 8 depicts an example of the control performed when a touch gesture performed on an object is detected through the touch screen 2B in the locked state in which the lock screen 60 is displayed. Step S11 to Step S12 illustrated in FIG. 8 represent how the locked state is released and the lock screen 60 is changed to the home screen 40.

Step S11 represents the locked state in which the lock screen 60 including the objects 61a to 61c is displayed. Step S11 represents a state in which a touch is performed on the object 61a that moves on the lock screen 60 with the user's finger. The smartphone 1 acquires a detection result of the touch screen 2B, and executes a lock-release function associated with the icon 50a included in the object 61a to release the locked state in response to detection of the touch performed on the object 61a from the detection result. After the release of the locked state, the smartphone 1 displays the home screen 40 on the display 2A as illustrated at Step S12.

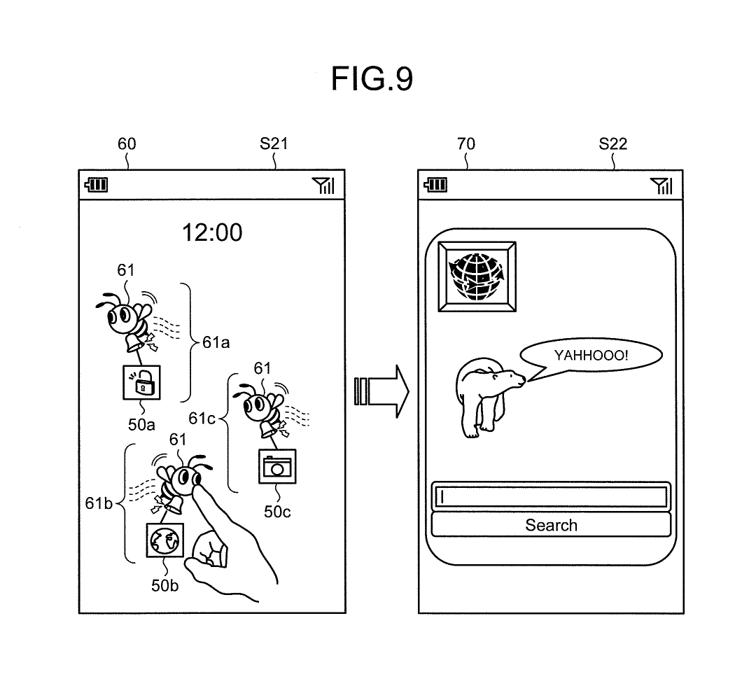

FIG. 9 depicts another example of the control performed when a touch gesture performed on an object is detected through the touch screen 2B in the locked state in which the lock screen 60 is displayed. Step S21 to Step S22 illustrated in FIG. 9 represent how the lock screen 60 is changed to a WEB browser screen 70.

Step S21 represents the locked state in which the lock screen 60 including the objects 61a to 61c is displayed. Step S21 represents a state in which a touch is performed on the object 61b that moves on the lock screen 60 with the user's finger. The smartphone 1 acquires a detection result of the touch screen 2B, and executes the browser application 9C associated with the icon 50b included in the object 61b in response to detection of the touch performed on the object 61b from the detection result. Subsequently, as illustrated at Step S22, the smartphone 1 displays the WEB browser screen 70 on the display 2A. The smartphone 1 may execute the browser application 9C associated with the object 61b while maintaining the locked state. That is, the smartphone 1 may execute the browser application 9C and then return again to the locked state. Alternatively, the smartphone 1 may release the locked state and execute the browser application 9C associated with the object 61b. That is, the smartphone 1 may be configured to execute the browser application 9C and then display the home screen 40 on the display 2A to make it possible to execute another application.

In the case of FIG. 8, the smartphone 1 releases the locked state, in which the lock screen is displayed, according to a touch gesture performed on the first object that moves on the lock screen 60. From these steps, according to the present embodiment, the operability of the lock-release operation can be improved. In the case of FIG. 9, the smartphone 1 executes the application associated with the second object according to a touch gesture performed on the second object that moves on the lock screen 60. At this time, the smartphone 1 releases the locked state and executes the application associated with the second object. From these steps, according to the present embodiment, the release of the locked state and the execution of the application can be simultaneously performed, thus further improving the operability of the lock-release operation.

In the cases of FIG. 8 and FIG. 9, the examples of the control to detect a touch as a touch gesture performed on the first object or the second object has been explained; however, the touch gesture is not limited thereto. For example, the smartphone 1 may detect a long touch, a tap, a double tap, or a flick as a touch gesture performed on the first object or the second object. Alternatively, the smartphone 1 may detect a swipe that moves on with the first object or the second object as a touch gesture performed on the first object or the second object. For example, the smartphone 1 may execute the lock-release function associated with the object 61a upon detecting a swipe performed on a trace made by the object 61a, which is an example of the first object, moving on the lock screen 60. Alternatively, the smartphone 1 may execute the WEB browser upon detecting a swipe performed on a trace made by the object 61b, which is an example of the second object, moving on the lock screen 60.

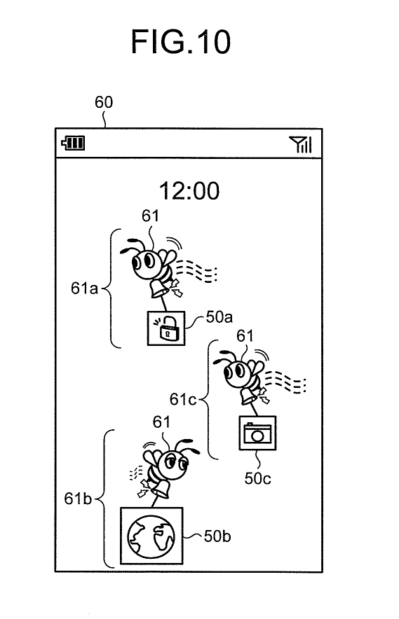

The functions provided by the control program 9A include a function of changing at least one of a size, a moving speed, a frequency of appearance, a cycle of appearance, an appearance span, a period of appearance, a detecting area of a gesture, and a movement pattern of an object displayed on the lock screen 60 according to a use frequency of an application or an event occurring in relation to the application. An example of the control to change the moving speed of an object displayed on the lock screen 60 and the size of an icon included in the object according to the use frequency of an application will be explained below with reference to FIG. 10. FIG. 10 is a diagram illustrating an example of the control to change the moving speed of an object displayed on the lock screen 60 and the size of an icon included in the object according to the use frequency of an application.

The lock screen 60 in FIG. 10 displays the three objects 61a to 61c. FIG. 10 depicts an example in which the application corresponding to the icon 50b included in the object 61b is frequently used among the three objects. Examples of “being frequently used” include, but are not limited to, a case in which an average of the number of use times per day excesses a preset threshold, or the like. The smartphone 1 acquires the use status data 9Y stored in the storage 9 at, for example, a preset time every day. The smartphone 1 calculates an average of the number of use times per day for each application using the number of use times for each of the applications included in the use status data 9Y. The smartphone 1 updates the average of the number of use times per day for each of the applications stored in the storage 9.

When the lock screen 60 is to be displayed on the display 2A, the smartphone 1 acquires a use frequency for each application from the storage 9. If there is a frequently used application, then upon and displaying an object associated with the application, the smartphone 1 changes, for example, the moving speed of the object and the size of an icon included in the object. As illustrated in FIG. 10, when the application corresponding to the object 61b is frequently used, that is, when the average of the number of use times exceeds the threshold, the smartphone 1 reduces the moving speed of the object 61b more than that of the object 61a and the object 61c. Moreover, the smartphone 1 increases the size of the icon 50b included in the object 61b more than that of the icon 50a included in the object 61a and that of the icon 50c included in the object 61c.

As illustrated in FIG. 10, the smartphone 1 changes the size and the moving speed of the object displayed on the lock screen 60 according to the use frequency of the application. This enables the user to more easily operate, for example, a more frequently used application.

In the case of FIG. 10, the example of changing the moving speed of the object and the size of the icon according to the frequently used application has been explained; however, the embodiment is not limited thereto. As for the frequently used application, for example, the smartphone 1 may change either the moving speed of the object or the size of the icon corresponding to the application. For example, the smartphone 1 may provide a plurality of thresholds and change at least either one of the moving speed of the object and the size of the object step by step according to the use frequency. For example, the smartphone 1 may change at least either one of the moving speed of the object and the size of the object in proportion to the use frequency.

In the case of FIG. 10, the example in which the smartphone 1 changes the moving speed of the object and the size of the icon corresponding to the frequently used application has been explained; however, the embodiment is not limited thereto. For example, the smartphone 1 may relatively change the moving speed of an object between the object and the other objects so that the moving speed of the object corresponding to a more frequently used application is reduced more than that of the others according to the use frequency of the application. Alternatively, the smartphone 1 may relatively change the size of an icon included in each of the objects between the object and the other objects so that the size of the icon corresponding to a more frequently used application is increased more than that of the others according to the use frequency of the application.

In the case of FIG. 10, the case in which the smartphone 1 changes the size of the icon corresponding to the frequently used application has been explained; however, the embodiment is not limited thereto. For example, the smartphone 1 may change the size of the image 61 of the bee without changing the size of the icon. Alternatively, the smartphone 1 may change both the size of the icon and the size of the image 61.

In the case of FIG. 10, the smartphone 1 may change the frequency of appearance, the cycle of appearance, the appearance span, the period of appearance, the detecting area of a gesture, or the movement pattern of an object. The control explained below enables the user to relatively easily execute a frequently used application. For example, the smartphone 1 may execute the control so as to cause an object corresponding to a frequently used application to frequently appear on the lock screen 60 or so as to cause an object corresponding to a frequently used application to rarely appear on the lock screen 60.

When the frequency of appearance and the period of appearance are to be changed, the smartphone 1 may execute the control, for example, so as to cause an object corresponding to a frequently used application to remain in the lock screen 60 for a long period of time or so as to cause an object corresponding to a frequently used application to disappear from the lock screen 60 in a short period of time.

When the contact-detected area is to be changed, the smartphone 1 may execute the control, for example, such that for an object corresponding to a frequently used application an area where a touch gesture performed thereon is detected is widen.

When the movement pattern is to be changed, the smartphone 1 may execute the control so as to move an object corresponding to a frequently used application in a regular movement pattern. The smartphone 1 may move an object corresponding to a frequently used application, for example, so as to circle on the lock screen 60. The smartphone 1 may move an object corresponding to a frequently used application, for example, so as to repeat its hovering and its movement for a given length of time on the lock screen 60. On the other hand, the smartphone 1 may execute the control so as to irregularly move an object corresponding to an infrequently used application on the lock screen 60.

In the case of FIG. 10, the case in which the smartphone 1 uses the average of the number of use times per day as a use frequency of an application has been explained; however, the embodiment is not limited thereto. For example, the smartphone 1 may use, instead of the use frequency, other index related to a use status, such as an accumulated number of use times of an application, a value as normalized number of use times of an application, an elapsed time since the last use, etc.

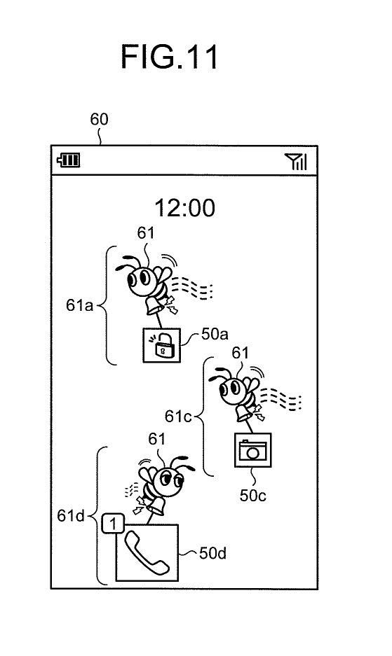

In the case of FIG. 10, the example in which the smartphone 1 changes the display mode of an object according to the use frequency of the corresponding application has been explained; however, the embodiment is not limited thereto. For example, the smartphone 1 may change the display mode of an object according to an event occurring in relation to the corresponding application, such as an incoming mail, an incoming call, an arrangement registered in Schedule, etc. This enables the user to easily operate, for example, the application in relation to which an event occurs. FIG. 11 depicts a modification of the display mode according to an event occurring in relation to an application.

As illustrated in FIG. 11, for example, when there is an incoming call, the smartphone 1 may reduce the moving speed of the object associated with the application for a phone call and increase the size of the icon corresponding to the application for the phone call. When there is a missed call, the smartphone 1 may also change the display mode to the display mode as illustrated in FIG. 11. As well as the case of FIG. 11, for example, when there is an incoming mail, the smartphone 1 may reduce the moving speed of the object associated with the mail application 9B and increase the size of the icon corresponding to the mail application 9B. For example, when an arranged time registered in Schedule is approaching, the smartphone 1 may reduce the moving speed of the object associated with an application for managing schedules and increase the size of the icon corresponding to a schedule function. The smartphone 1 may change the frequency of appearance, the cycle of appearance, the appearance span, the period of appearance, the detecting area of a gesture, and the movement pattern of an object, similarly to the case of FIG. 10, according to an event occurring in relation to the application.

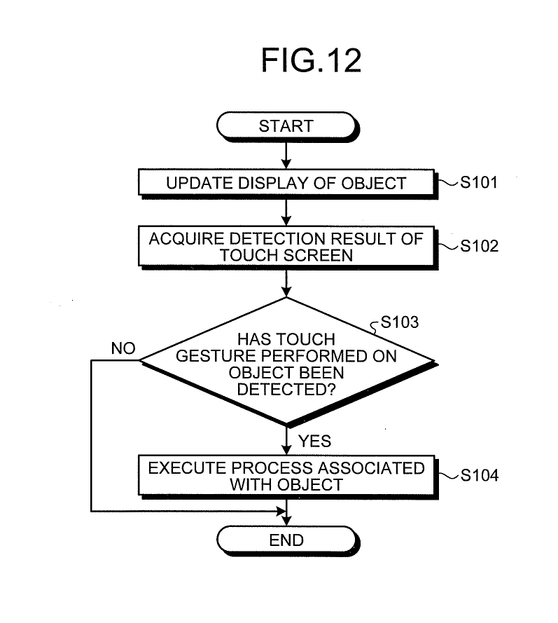

An example of a procedure of the control based on the functions provided by the control program 9A will be explained below with reference to FIG. 12. FIG. 12 depicts the procedure for executing a process associated with an object according to a touch gesture performed on the object detected through the touch screen 2B. The procedure in FIG. 12 is implemented by the controller 10 executing the control program 9A. The procedure in FIG. 12 is repeatedly executed by the controller 10 while the locked state is maintained.

As illustrated in FIG. 12, at Step S101, the controller 10 updates the display mode of an object. For example, the controller 10 changes the moving speed of the object and the size of the icon corresponding to a frequently used application, or changes the frequency of appearance, the cycle of appearance, the appearance span, the period of appearance, the detecting area of a gesture, or the movement pattern of the object.

Subsequently, at Step S102, the controller 10 acquires a detection result of the touch screen. Then, at Step S103, the controller 10 determines whether a touch gesture performed on the object displayed on the lock screen 60 has been detected. For example, the controller 10 determines whether a touch performed on the object displayed on the lock screen 60 has been detected from the detection result of the touch screen 2B.

When the touch gesture has been detected as the result of determination (Yes at Step S103), then at Step S104, the controller 10 executes the process associated with the object. For example, when the touch performed on the object 61a in FIG. 8 has been detected from the detection result of the touch screen 2B, the controller 10 executes the lock-release function associated with the object 61a, and releases the locked state. For example, when the touch performed on the object 61b in FIG. 9 has been detected, the controller 10 executes the WEB browser associated with the object 61b.

On the other hand, when the touch gesture has not been detected as the result of determination (No at Step S103), the controller 10 ends the process.

The embodiment disclosed in the present application can be modified without departing the gist and the scope of the invention. Moreover, the embodiments and their modifications disclosed in the present application can be combined with each other if necessary. For example, the embodiment may be modified as follows.

For example, the programs illustrated in FIG. 5 may be divided into a plurality of modules, or may be combined with any other program.

In the embodiment, the smartphone has been explained as an example of the device provided with the touch screen; however, the device according to the appended claims is not limited to the smartphone. The device according to the appended claims may be a mobile electronic device other than the smartphone. Examples of the mobile electronic devices include, but are not limited to, mobile phones, tablets, mobile personal computers, digital cameras, media players, electronic book readers, navigators, and gaming devices. The device according to the appended claims may be a stationary-type electronic device. Examples of the stationary-type electronic devices include, but are not limited to, desktop personal computers, automatic teller machines (ATM), and television receivers.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A device comprising:
a touch screen display for displaying a lock screen and a first object that moves on the lock screen; and
a controller for releasing, when a gesture is performed on the first object, a locked state in which the lock screen is displayed.

2. The device according to claim 1, wherein
the touch screen display is configured to further display a second object that is associated with an application and moves on the lock screen, and
the controller is configured to execute, when a gesture is performed on the second object, the application associated with the second object.

3. The device according to claim 2, wherein
the touch screen display is configured to change at least one of a size, a moving speed, a frequency of appearance, a cycle of appearance, an appearance span, a period of appearance, a detecting area of a gesture, and a movement pattern of the second object according to a use frequency of the application.

4. The device according to claim 2, wherein
the touch screen display is configured to change at least one of a size, a moving speed, a frequency of appearance, a cycle of appearance, an appearance span, a period of appearance, a detecting area of a gesture, and a movement pattern of the second object according to an event occurring in relation to the application.

5. The device according to claim 2, wherein
the controller is configured to
release the locked state when a gesture moving on with the first object is performed, and
execute the application associated with the second object when a gesture moving on with the second object is performed.

6. A method for controlling a device with a touch screen display, the method comprising:
displaying a lock screen and a first object that moves on the lock screen on the touch screen display; and
releasing, when a gesture is performed on the first object, a locked state in which the lock screen is displayed.

7. A non-transitory storage medium that stores a program for causing, when executed by a device with a touch screen display, the device to execute:
displaying a lock screen and a first object that moves on the lock screen on the touch screen display; and
releasing, when a gesture is performed on the first object, a locked state in which the lock screen is displayed.
